(19) United States
(12) Patent Application Publication
(10) Pub. No.: US 2023/0059893 A1
(43) Pub. Date: Feb. 23, 2023

(54) Roller Mill Having Grinding Rollers Set At An Angle

(71) Applicant: Gebr. Pfeiffer SE, Kaiserslautern (DE)

(72) Inventors: Johannes ALVE, Hochspeyer (DE); Saskia HANAUER, Carlsberg (DE); Dirk HOFFMANN, Trippstadt (DE)

(21) Appl. No.: 17/792,650

(22) PCT Filed: Jan. 14, 2020
(86) PCT No.: PCT/EP2021/050682

§ 371 Date: Jul. 13, 2022

(30) Foreign Application Priority Data
Jan. 14, 2020 (EP) 20151718.2

(51) Int. Cl. B02C 15/00

(52) U.S. Cl. CPC B02C 15/004; B02C 2015/008

(57) ABSTRACT

A roller mill, having a grinding table and grinding rollers, wherein the grinding table is rotatable relative to the grinding rollers about a center axis of the grinding table in a grinding table rotation direction, such that the grinding rollers roll on a grinding track of the grinding table about a roller rotation axis. At least one of the grinding rollers is rotated to be set at a set angle in the direction of the grinding table rotation direction, such that the roller rotation axis extends at a radial distance from the center axis of the grinding table. The set angle is between 1 degree and 9 degrees. A method for operating a roller mill, and the use of a roller mill for comminuting particulate bulk material are also disclosed.

The present invention relates to a roller mill, a method for operating a roller mill, and the use of a roller mill for comminuting particulate bulk material.

In prior art, roller mills having a grinding table and grinding rollers are known, wherein the grinding rollers can be rotated to be set at a set angle. It is known, for example, from EP 2 252 403 B1 to disengage one or more grinding rollers from the grinding table during the deactivation of one or more drives of a grinding table, and to set the remaining grinding rollers at an angle for further reducing the radial force. It is in particular taught in prior art to set rollers at an angle against the rotation direction of the grinding table, for example in U.S. Pat. No. 1,661,297, or DE 32 40 931 A1.

Furthermore, quite large set angles are often taught in prior art, for example in DE 10 2007 009 723 A1, DE 10 2008 039 541 A1, or CN 105 080 665 A. According to CN 105 080 665 A, a frictional force in the direction of the edge of the grinding table is generated by the set angles, that means, the grinding roller is rotated to be set at a set angle against the grinding table rotation direction. JP 11 156 220 A discloses a set angle range of 3 degrees against the grinding table rotation direction to 0.7 degrees in the direction of the grinding table rotation direction. It is explained there that with set angles against the grinding table rotation direction above 3 degrees, the motor torque would become too high. It is advised not to use set angles above 0.7 degrees in the grinding table rotation direction since vibrations are expected in this case.

It is the object of the present invention to provide a roller mill and a method and use for operating roller mills, which allow a more uniform grinding result and an increased grinding performance without essentially increasing wear.

The invention provides a roller mill with a grinding table and grinding rollers, wherein the grinding table is rotatable relative to the grinding rollers about a center axis of the grinding table in a grinding table rotation direction, such that the grinding rollers roll on a grinding track of the grinding table about a roller rotation axis. At least one of the grinding rollers is rotated to be set at a set angle in the direction of the grinding table rotation direction, such that the roller rotation axis extends at a radial distance from the center axis of the grinding table. The set angle is between 1 degree and 9 degrees according to the invention.

In one embodiment, the set angle is between 1 degree and 4.5 degrees.

In preferred embodiments, the set angle is between 1 degree and 3 degrees, between 1 degree and 2 degrees, between 2 degrees and 3 degrees, between 2.5 degrees and 3.5 degrees, between 3 degrees and 4.5 degrees, between 2 degrees and 9 degrees, between 3 degrees and 8 degrees, or between 4 degrees and 7 degrees. Set angles above 9 degrees, in particular above 4.5 degrees, can lead to an unnecessarily high driving torque of the at least one drive of the grinding table without improving the grinding result.

The roller mill is in particular designed to grind grinding stock in the form of particulate bulk material. The particulate bulk material is in particular ground rock material, for example limestone, gypsum, coal or claystone, mineral bulk material, for example cement or cement raw material, or recycled bulk material, for example recycled plaster concrete plate material, blast furnace slag, flue gas gypsum, or flue ash.

A set angle in the range according to the invention for rotating the grinding roller to be set at an angle in the direction of the grinding table rotation direction increases the shearing forces between the grinding roller and the grinding table since now relative speeds, i.e. slippage, between the grinding roller and the grinding table additionally occur in the radial direction. These shearing forces generate additional friction, which in turn generates damping whereby vibrations are reduced. This permits the formation of a uniform grinding bed thickness where it is in particular prevented that the grinding bed becomes too thin in some regions. Thereby, the wear of the grinding rollers and the grinding table can also be reduced. The set angles according to the invention permits the roller mill to run more uniformly, that means, in particular less fluctuating normal forces act between the grinding table and the grinding rollers, whereby a more uniform and efficient grinding operation is permitted. The normal force is the force that acts from the grinding roller on the grinding table in the normal direction of the surface of the grinding track.

Grinding stock is comminuted in the roller mill, but it can be compressed again into agglomerates by the grinding pressure, which are then returned to the grinding operation or to the grinding table due to their size in the classifier. By the additional shearing forces due to the set angle, the formation of agglomerates can be avoided. The shearing forces break up major components in the grinding stock, in particular agglomerates and/or scabs, so that their individual particles leave the grinding region via the classifier more quickly. The set angle in particular causes shearing forces to act in the radially inner direction of the grinding table. By this, a more thorough grinding operation can be achieved.

The ground particulates are taken by an air flow radially outside the grinding table and guided to a classifier. In the classifier, undersized material that has already reached the desired particle size is separated and discharged, and oversized material that needs to be reground again is guided back to the grinding table. However, agglomerates are also guided back to the grinding table due to their size. By the set angles according to the invention, the formation of agglomerates can be at least reduced, and further regrinding can be avoided. Altogether, grinding efficiency thus increases.

In particular, the roller mill is designed such that the grinding table can only be driven in the grinding table rotation direction relative to the grinding rollers. This can be, for example, conditioned by a driving gear, which is only designed for the operation in the grinding table rotation direction. As an alternative or in addition, an electronic control is provided which is configured to control the at least one drive of the grinding table such that the grinding table only rotates in the grinding table rotation direction. This can prevent the roller mill from being operated against the intended grinding table rotation direction, which would have negative effects on the grinding result.

In one embodiment, the grinding roller is of a cylindrical shape in the contact region with the grinding track. In particular, the grinding track is then correspondingly shaped to be plane. By the cylindrical shape, one can in particular achieve that shearing forces are generated in the circumferential direction of the grinding table between the grinding table and the grinding roller. Furthermore, the plane grinding region between a cylindrical grinding roller and the plane grinding track is advantageous in view of the transport of the grinding stock on the grinding table. In particular, the cylindrical shape of the grinding roller can permit a constant slippage speed in the transverse direction of the grinding roller.

Advantageously, the grinding roller has a cylindrical shape at least in a range of 70%, advantageously 80%, even more advantageously 90%, of its extension in the axial direction and is only provided with roundings in its axial edge regions.

The ratio of the diameter of the grinding roller to the width of the grinding roller is advantageously 1.5 to 6, in preferred embodiments, the ratio can be 2 to 5, 3 to 5, 3.5 to 5, or 2 to 4, and in even more preferred embodiments 3 to 4. That means, the grinding roller has a relatively large diameter in view of its width, so it is a comparably narrow grinding roller. Thereby, in particular a high local grinding pressure or a high specific surface pressure can be applied, whereas the formation of vibrations or an excessively high driving torque can be prevented.

In preferred embodiments, the ratio between the radial distance from the center axis of the grinding table to the axial center of the grinding roller and the width of the grinding roller is between 1.5 and 6. In other embodiments, this ratio can also be between 1.5 and 5. In further preferred embodiments, the ratio is between 1.75 and 5 or 3.5 and 5. These ratios in particular permit relatively small grinding rollers with respect to quite large grinding table diameters which can provide, in combination with the set angles according to the invention, an advantageous grinding result without increasing vibrations. In particular, the specific required amount of work, i. e. drive energy (kWh) per mass (kg), can be reduced. The reason for this is, among other things, that an energy consumption for breaking up agglomerates, for unnecessary regrinding, for elastic deformation and/or for vibrations can be avoided.

Preferably, the ratio between the radial distance from the center axis of the grinding table to the axial center of the grinding roller and the diameter of the grinding roller is between 0.5 and 1.5. In other embodiments, this ratio can also be between 0.6 and 1.3.

Advantageously, the grinding track is formed by a plane region of the grinding table, in particular, the regions of the grinding table adjacent to the grinding track radially inside and radially outside are also plane. In particular, the complete grinding table can be designed to be plane. By the plane region, an advantageous transport of the grinding stock through the grinding gap between the grinding roller and the grinding table can be accomplished. In particular, an advantageous transport of grinding stock in the direction of the interior of the grinding table can be achieved by a combination with the set angles according to the invention.

In one embodiment, the grinding roller is rotatable about an axially central contact point on the grinding track. This has the advantage that set angles can be achieved without having to change the contact point of the grinding roller. Thereby, the introduction of the normal force between the grinding roller and the grinding table remains at the same site, which can be advantageous in view of the bearing of the grinding table. As an alternative, it is, however, also possible to linearly shift the grinding roller in a direction deviating from the radial direction of the grinding table, in particular in an orthogonal direction with respect to the radial direction of the grinding table. This also results in set angles of the grinding roller. The ability to rotate the grinding roller to be set at an angle can in particular be achieved by a guide having the shape of a circular segment. A linear adjustment can in particular be achieved by a linear guide. In particular, the guides can be designed as guiding slots. In particular, fastening can be accomplished by frictional contact or by positive engagement by means of screws.

In one embodiment, several grinding rollers are provided, where only a subassembly of the grinding rollers is set at an angle. In particular, all grinding rollers in the subassembly are rotated to be set at the set angle in the direction of the grinding table rotation direction. If only a subassembly of the grinding rollers is rotated to be set at an angle, grinding rollers not set at an angle are also in contact with the grinding table. In one embodiment, all grinding rollers can be rotated to be set at the set angle in the direction of the grinding table rotation direction.

In one embodiment, the roller rotation axis is parallel to the surface of the grinding table. In particular, the roller rotation axis can be provided orthogonally to the rotation axis of the grinding table. In particular, the rotation axis of the grinding table is vertical. In particular, the roller rotation axis is horizontal. By the orthogonality of the roller rotation axis with respect to the rotation axis of the grinding table, it is achieved that, starting from the axial center of the grinding roller in the circumferential direction of the grinding roller, a slippage with respect to the grinding table occurs in each case. In the process, shearing forces act in the radially outer region of the grinding track against the rotation direction of the grinding table, and in the radially inner region of the grinding track, in the rotation direction of the grinding table.

In an alternative embodiment, the rotation axis of the grinding roller can be inclined at an angle of 0.5 degree to 20 degrees with respect to the surface of the grinding table. In particular, the rotation axis of the grinding roller is inclined at an angle of 0.5 degree to 10 degrees or of 10 degrees to 18 degrees, advantageously of 12 degrees to 15 degrees with respect to the surface of the grinding table. The inclination of the rotation axis can in particular be combined with conically shaped rollers. In addition or as an alternative, the grinding track can also be designed to be inclined with respect to the radial direction of the grinding table. By the inclination of the rotation axis in particular in combination with conical rollers and/or an inclined grinding track, the slippage, and thus the shearing forces, between the grinding rollers and the grinding track can be influenced. It is in particular possible not to provide any slippage in the circumferential direction of the grinding table between the grinding roller and the grinding track, but only the slippage generated by the set angle in the radial direction of the grinding table. Thereby, in some applications, a particularly uniform grinding result can be achieved. In particular, the axis of rotation of the grinding roller is inclined such that it would intersect, without set angles, a vector in the radial direction of the grinding table starting from the grinding track in the rotation axis of the grinding table.

In one embodiment, a rocker arm is provided, the rocker arm being mounted to be pivotable about a bearing axis. The grinding roller is in particular rotatably mounted in the rocker arm about the roller rotation axis, the bearing axis of the rocker arm advantageously being parallel to the roller rotation axis. Thus, a height compensation of the grinding roller for different thicknesses of the grinding stock is achieved, whereby the roller rotation axis is shifted in parallel. Thereby, the grinding gap can remain parallel, and only its thickness can be changed. Thus, a uniform grinding result can be achieved.

In one embodiment, the rocker arm is mounted radially outside the grinding table in a bracket, which is mounted in the base. Thus, the forces acting on the grinding roller can be directly discharged into the base via the rocker arm.

The invention furthermore provides a method for operating an above-described roller mill, wherein the grinding table is rotated at a speed such that a radial acceleration of at least 1 g acts on the grinding stock radially to the outside on the grinding table in the region of the radial center of the grinding track. g is the gravity acceleration constant of 9.81 m/s\hat{ }2 (9.81 meters per second squared).

In further embodiments of the method, the grinding table is rotated at a rotational speed such that a radial acceleration of at least 1.1 g or at least 1.2 g acts on the grinding stock on the grinding table in the region of the radial center of the grinding track.

In advantageous embodiments of the method, the grinding table is rotated at a rotational speed such that a radial acceleration of at least 1.3 g, at least 1.4 g, or at least 1.5 g acts on the grinding stock on the grinding table in the region of the radial center of the grinding track.

The comparably high rotational speeds are enabled since the at least one grinding roller rotated to be set at a set angle in the direction of the grinding table rotation direction applies a shearing force on the grinding stock which acts radially inwards, and thus counteracts the acceleration force acting on the grinding stock radially outwards due to the radial acceleration.

It is thus achieved that, despite high grinding table speeds and correspondingly high radial accelerations, sufficient grinding stock is always present in the grinding gap between the grinding roller and the grinding table, and thus a high grinding performance is reached and wear is reduced.

The invention furthermore provides a method for operating a roller mill, wherein grinding rollers roll on a grinding table, wherein the slippage speed in the transverse direction of the grinding rollers is constant at least over a contact region in the width of the grinding rollers. Thereby, a reduction of vibrations and an improvement of the grinding result can be achieved. The method advantageously permits to counteract the formation of agglomerates. In particular, the method comprises the step of providing at least one grinding roller, which is rotated to be set at a set angle in a range of 1 degrees to 9 degrees, in one embodiment of 1 degrees to 4.5 degrees, in the direction of the grinding table rotation direction. Advantageously, the grinding roller is of a cylindrical shape in the contact region with the grinding track.

In particular, by means of the slippage speed in the transverse direction of the grinding roller, grinding stock is transported in the direction of the interior of the grinding table. The transverse direction of the grinding roller is the axial direction of the grinding roller. By the grinding rollers transporting grinding stock in the direction of the interior, the slippage counteracts the centrifugal forces, which transport grinding stock to the outside by the rotation of the grinding table. Thus, an increased residence time of the grinding stock in the region of the grinding rollers with simultaneously high grinding table rotation speeds can be achieved, leading to an improved grinding result.

Finally, the invention provides the use of a roller mill for comminuting particulate bulk material, wherein by set angles of at least one grinding roller in the rotation direction of a grinding table, the vibrations of the roller mill with respect to the state of grinding rollers not set at an angle are reduced. In prior art, the vibrations are increased compared to the state not set at an angle in corresponding applications. The method according to the invention and the use according to the invention, however, permit the reduction of vibrations with a constant or even improved grinding result, in particular by the operation of the above-defined embodiments of roller mills.

The invention will be further illustrated below with reference to exemplary embodiments which are represented in the following figures. In the drawings:

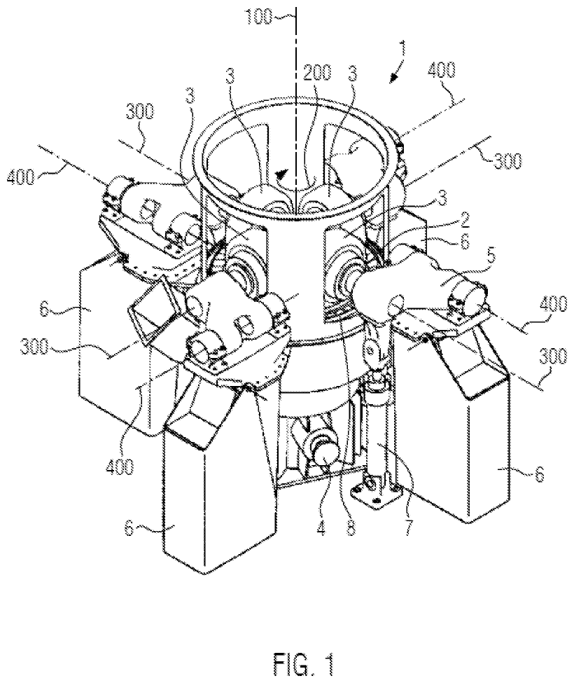

FIG. 1 shows a perspective view of a roller mill in accordance with one embodiment of the present invention;

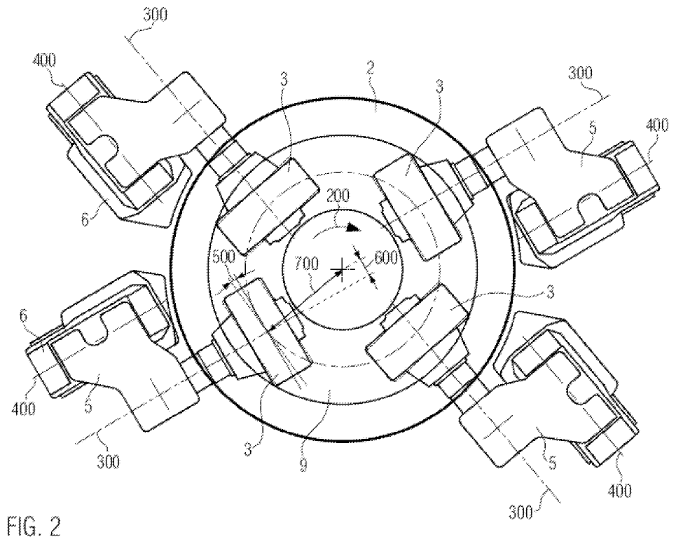

FIG. 2 shows a plan view onto of a roller mill according to an embodiment of the invention;

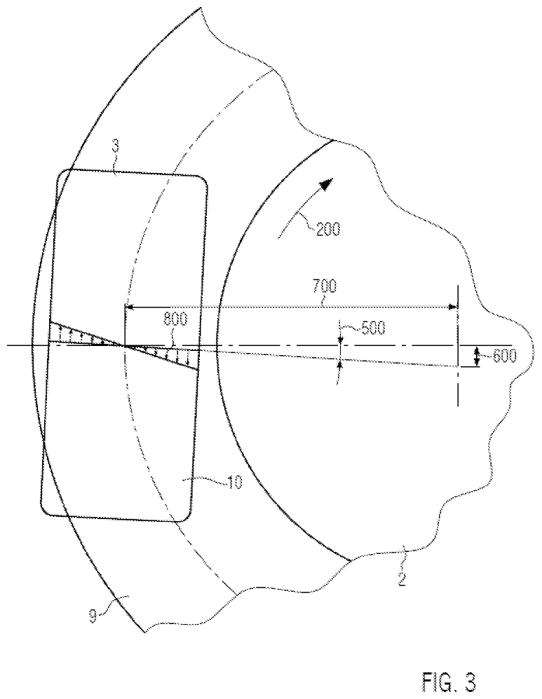

FIG. 3 shows a schematic view of the grinding table and the grinding roller of a roller mill according to an embodiment of the invention with a representation of the slippage speed in the circulation direction of the grinding table; and

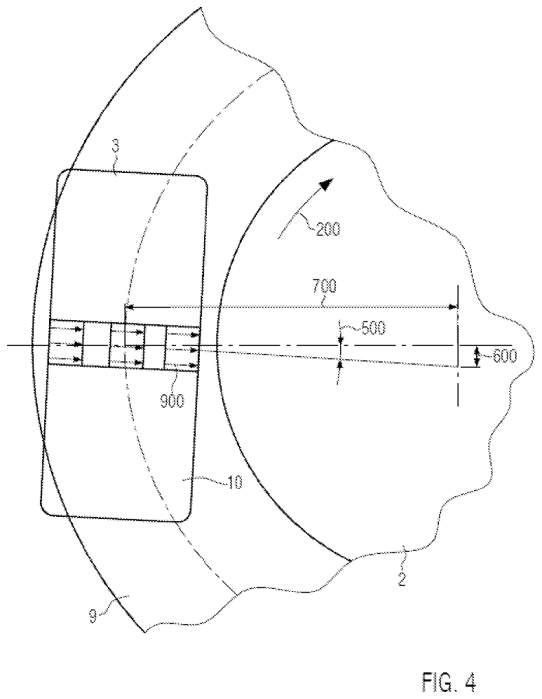

FIG. 4 shows a schematic view of the grinding table and the grinding roller of a roller mill according to an embodiment of the invention with a representation of the slippage speed in the radial direction of the grinding table.

In FIG. 1, a roller mill according to an exemplary embodiment of the invention is shown. The roller mill has a grinding table 2 and four grinding rollers 3. The grinding table 2 is driven about its center axis 100 in a grinding table rotation direction 200. For this, at least one grinding table drive 4 is provided. The grinding roller 3 is mounted in a rocker arm 5 about a roller rotation axis 300. The rocker arm 5 is mounted in a bracket 6 so as to pivot about a bearing axis 400. The bracket 6 is directly attached to the base. Furthermore, hydraulic cylinders 7 can be provided which are connected, spaced apart from the bearing axis 400, with the rocker arm 5 and can apply a force onto the rocker arm 5 starting from the base. This can serve to deflect the grinding rollers 3 from the engagement with the grinding table 2, or to adjust the normal force between the respective grinding roller 3 and the grinding table 2.

In the inner region of the grinding table 2, particulate bulk material is introduced which then moves radially outwards on the grinding table 2, so that it is ground between the grinding rollers 3 and the grinding table 2. Then, the ground bulk material is subjected to an air flow through a nozzle ring 8 disposed radially outside the grinding table. The air flow supplies the ground bulk material to a non-depicted classifier, which can return coarse components back to the grinding table 2 and discharges sufficiently fine particulates from the roller mill 1.

In FIG. 2, a plan view onto the grinding table 2, the grinding rollers 3, and their mounting is represented. The grinding rollers 3 are represented in dashed lines in their arrangement without set angles, and in solid lines in their set angle arrangement. Here, the grinding rollers are rotated to be set at a set angle 500 in the direction of the grinding table rotation direction 200. Thereby, the roller rotation axis 300 extends at a radial distance 600 from the center axis 100 of the grinding table 2. The grinding rollers 3 form a grinding gap in the region of a grinding track 9 in which particulate bulk material lying on the grinding table 2 is ground by means of normal and shearing forces.

The axial center of the grinding rollers 3 is at a radial distance 700 from the center axis 100 of the grinding table 2. The axial center of the grinding roller 3 in particular also defines the radial center of the grinding track 9. According to FIG. 2, the set angles are achieved by a rotating of the grinding roller 3 about the axial central contact point of the grinding roller 3 on the grinding table 2. For this, a guide having the shape of a graduated circle can be provided in particular in the bracket 6 by which the rocker arm 5 can be moved with respect to the bracket 6. As an alternative or in addition, the set angles can be achieved by linearly moving the grinding roller 3, in particular in its radial direction. Thereby, however, the position of the axial central contact point of the grinding roller 3 with respect to the grinding table 2 is changed.

In FIG. 3 and FIG. 4, the slippage between a grinding roller 3 at a set angle and the grinding table 2 is represented. As can be taken from FIG. 3, the speed of the grinding table in the circumferential direction is calculated as a linear function in response to the radius. The speed of the cylindrical grinding roller 3 mounted in parallel to the grinding table 2 and orthogonally to its center axis 100, however, is equal along its axial extension. Consequently, the grinding roller 3 only driven by the grinding table 2 runs faster at its radially inner end with respect to the grinding table than the corresponding region of the grinding track 9. In its radially outer region 11 with respect to the grinding table 2, the grinding roller 3 runs slower than the grinding table 2. This causes slippage between the grinding roller 3 and the grinding table 2, which respectively leads to shearing forces that could serve the grinding operation. By the rotated arrangement at the set angle 500 in the direction of the grinding table rotation direction 200, according to the above illustrated geometry and arrangement, a constant slippage 900 is caused in the radial direction of the grinding table 2, wherein the slippage speed is constant along the total axial extension of the grinding roller 3, that means over the total contact region in the width of the grinding roller 3. Thereby, shearing forces are generated which act to the inside in the radial direction of the grinding table 2 and thus counteract the centrifugal force acting on the particulate bulk material rotating with the grinding table 2. This allows to achieve an improved grinding of the bulk material, where in particular less vibrations are generated than by set angles not designed according to the invention. By the uniform grinding, more grinding stock can pass the classifier, whereby the proportion of grinding stock that has to be reground is reduced, so that altogether an increase of the capacity of the roller mill is achieved.

In one embodiment of the method according to the invention, the above illustrated roller mill 1 is operated by rotating the grinding table 2, so that the grinding rollers 3 roll thereon, wherein by set angles of the grinding rollers 3, a constant slippage speed 900 is achieved in the transverse direction or axial direction of the grinding rollers 3. In particular, by the slippage speed 900, grinding stock is transported in the direction of the radial interior of the grinding table 3 or counteracts the centrifugal force in some regions, so that a better grinding effect is permitted. Thus, the roller mill can be used for reducing the vibrations in the roller mill by the set angles, and wherein simultaneously, an improved grinding result is generated.

1. A roller mill (1), comprising:
a grinding table (2) and grinding rollers (3);
wherein the grinding table (2) is rotatable relative to the grinding rollers about a center axis (100) of the grinding table (2) in a grinding table rotation direction (200), such that the grinding rollers (3) roll on a grinding track (9) of the grinding table (2) about a roller rotation axis (300);
wherein at least one of the grinding rollers (3) is oriented at a set angle (500) in the direction of the grinding table rotation direction (200), such that the roller rotation axis (300) of the at least one grinding roller (3) extends at a radial distance (600) from the center axis (100) of the grinding table (2);
wherein the set angle (500) is between 1 degree and 9 degrees.

2. The roller mill according to claim 1, wherein the set angle (500) is between 1 degree and 4.5 degrees.

3. The roller mill according to claim 1, wherein the at least one grinding roller (3) is of a cylindrical shape in a contact region with the grinding track (9).

4. The roller mill according to claim 1, wherein a ratio of a diameter of the at least one grinding roller (3) to a width of the grinding roller is 1.5 to 6.

5. The roller mill according to claim 1, wherein a ratio between the radial distance from the center axis (100) of the grinding table (2) to an axial center of the at least one grinding roller (3) and a width of the at least one grinding roller (3) is between 1.5 and 6.

6. The roller mill according to claim 1, wherein a ratio between the radial distance from the center axis (100) of the grinding table (2) to an axial center of the at least one grinding roller (3) and a diameter of the at least one grinding roller (3) is between 0.5 and 1.5.

7. The roller mill according to claim 1, wherein the grinding track (9) is formed by a plane region of the grinding table (2).

8. The roller mill according to claim 1, wherein the at least one grinding roller (3) is rotatable about its axially central contact point on the grinding track (9).

9. The roller mill according to claim 1, wherein the grinding rollers (3) comprise at least two grinding rollers (3) and only a subset of the at least two grinding rollers (3) is oriented at a set angle (500) in the direction of the grinding table rotation direction (200), such that the roller rotation axis (300) of each grinding roller (3) of the subset extends at a radial distance (600) from the center axis (100) of the grinding table (2).

10. The roller mill according to claim 1, wherein the roller rotation axis (300) of the at least one grinding roller (3) is orthogonal to the rotation axis (100) of the grinding table (2) and/or parallel to a surface of the grinding table (2).

11. The roller mill according to claim 1, wherein the roller rotation axis (300) of the at least one grinding roller (3) is inclined at an angle of 0.5 degree to 20 degrees with respect to a surface of the grinding table (2).

12. The roller mill according to claim 1, further comprising a rocker arm (5), wherein the rocker arm (5) is pivotally mounted about a bearing axis (400), wherein the at least one grinding roller (3) is rotatably mounted to the rocker arm (5) about the roller rotation axis (300), and wherein the bearing axis (400) of the rocker arm (5) is parallel to the roller rotation axis (300).

13. The roller mill according to claim 12, wherein the rocker arm (5) is mounted radially outside the grinding table (2) to a bracket (6) so as to be pivotable about the bearing axis (400), wherein the bracket (6) is mounted to a base.

14. A method for operating a roller mill (1) according to claim 1, wherein the grinding table (2) is rotated at a rotational speed such that on the grinding table (2) in a radial center of the grinding track (9), a radial acceleration of at least 1 g acts on grinding stock, wherein g is the normal gravity acceleration of 9.81 m/s\hat{ }2.

15. The method according to claim 14, wherein the radial acceleration is at least 1.3 g, advantageously at least 1.4 g.

16. A method for operating a roller mill (1), comprising:
rolling grinding rollers (3) on a grinding table (2), wherein a slippage speed in a transverse direction is constant between the grinding table (2) and at least one of the grinding rollers (3) over at least one contact region in a width of the at least one grinding roller (3).

17. The method according to claim 16, further comprising transporting grinding stock (3) in a direction of an interior of the grinding table (2) due to the slippage speed in the transverse direction of the at least one grinding.

18. A method for using a roller mill (1) for comminuting particulate bulk material, wherein due to a set angle of at least one grinding roller (3) in a rotation direction (200) of a grinding table, vibrations of the roller mill (1) are reduced compared to a state of the roller mill (1) with grinding rollers (3) not set at the set angle.
